(19) United States
(12) Patent Application Publication
(10) Pub. No.: US 2017/0258102 A1
(43) Pub. Date: Sep. 14, 2017

(54) AERATED STRAINED FERMENTED DAIRY COMPOSITIONS AND METHODS FOR PREPARATION

(71) Applicant: GENERAL MILLS, INC., Minneapolis, MN (US)

(72) Inventors: Darin HAIDER, Inver Grove Heights, MN (US); Katie MOELLER, St. Louis Park, MN (US); Reed TAYLOR, Champlin, MN (US)

(73) Assignee: General Mills, Inc., Minneapolis, MN (US)

(21) Appl. No.: 15/037,101

(22) PCT Filed: Sep. 19, 2014
(86) PCT No.: PCT/US14/56588

§ 371 Date: May 17, 2016

(51) Int. Cl. A23C 9/123; A23C 9/13; A23C 9/137

(52) U.S. Cl. CPC A23C 9/123; A23C 9/137; A23C 9/1307; A23C 9/1315

(57) ABSTRACT

The present disclosure relates to aerated strained fermented dairy compositions and processes for making aerated strained fermented dairy compositions. In particular, an aerated strained fermented dairy composition is disclosed that includes a strained fermented dairy ingredient, gelatin, and an emulsifier composition, where the aerated strained fermented dairy composition has a lower density than the strained fermented dairy ingredient.

### TECHNOLOGY

The present disclosure generally relates to products and methods related to an aerated strained yogurt product.

### BACKGROUND

Yogurt is a popular and nutritious dairy product, with recent increases in demand for strained yogurt (e.g., Greek style yogurt). One reason for the recent popularity of strained yogurt is that it typically contains a higher concentration of protein than traditional yogurt. However, although strained yogurt has proliferated on the grocery aisle, there has been little variation in the availability of strained yogurt styles and, despite a higher protein content, which is often desired, many people object to the taste and/or texture of strained yogurt. Thus, there is a need for a new variety of strained yogurt to provide greater choice and enjoyable eating experiences for consumers.

### SUMMARY

Provided herein is a method for making an aerated strained fermented dairy composition. The method includes providing a fermented dairy base having a pH of about 4.3 to about 4.7, removing whey from the fermented dairy base to produce a strained fermented dairy ingredient, producing a stabilized base, aerating the stabilized base to a density of from about 0.5 g/cc to about 1.0 g/cc. The stabilized base is produced by admixing a gelatin slurry into the strained fermented dairy ingredient and admixing a pasteurized emulsifier composition into the strained fermented dairy ingredient, the pasteurized emulsifier composition comprising wetting agent and a lactylated emulsifier.

The pasteurized emulsifier composition can include lactylated mono- and diglycerides and the wetting agent is selected from the group consisting of diacetyl tartaric acid esters of mono- and diglycerides (DATEM), polysorbates, propylene glycol esters, sodium dodecyl sulphate, sodium stearyl lactylate, and mixtures thereof.

The aerated strained fermented dairy composition can include about 0.01% to about 0.1% wetting agent and about 0.2% to about 1% lactylated emulsifier. The pasteurized emulsifier composition can further include a fruit ingredient, a flavor ingredient, a sweetener, or a color ingredient.

In some embodiments, the pasteurized emulsifier composition can be included in the gelatin slurry.

The gelatin slurry can include about 10% to about 35% gelatin by weight. In some embodiments, the gelatin slurry can be pasteurized.

In some embodiments, the gelatin slurry can be at a temperature of from about 120° F. to about 170° F.

In some embodiments, the stabilized base can be aerated at a temperature of about 40° F. to about 85° F.

In some embodiments, the protein content of the strained fermented dairy ingredient can be from about 7% to about 15% by weight.

In some embodiments, the strained fermented dairy ingredient can have a fat content of from 0% to about 10% by weight.

In some embodiments, the aerated strained fermented dairy composition includes gelatin in an amount of from about 0.3% to about 1.5% by weight.

In some embodiments, the aerated strained fermented dairy composition can have a fat content of from 0% to about 8% by weight.

Provided herein is in aerated strained fermented dairy composition having a viscosity of about 50,000 cps to about 200,000 cps at 40° F. and having a density of from about 0.5 g/cc to about 1.0 g/cc for at least 7 days at 35° F. to 45° F. at atmospheric pressure. The aerated strained fermented dairy composition includes about 65% to about 90% of a strained fermented dairy ingredient, about 0.3% to about 1.5% gelatin, about 0.01% to about 0.1% wetting agent and about 0.2% to about 1% lactylated emulsifier, and an aerating gas.

In some embodiments, the lactylated emulsifier can be lactylated mono- and diglycerides and the wetting agent can be selected from the group consisting of diacetyl tartaric acid esters of mono- and diglycerides (DATEM), polysorbates, propylene glycol esters, sodium dodecyl sulphate, sodium stearyl lactylate, and mixtures thereof.

In some embodiments, the aerated strained fermented dairy composition can have a starch content of less than 0.4% by weight.

In some embodiments, the aerated strained fermented dairy composition further includes a live and active culture.

In some embodiments, the aerated strained fermented dairy composition can have a compressibility of about 300 g force to about 800 g force.

In some embodiments, the aerated strained fermented dairy composition further includes particulates.

Also provided is a layered packaged food product comprising an aerated fermented dairy composition provided herein as a layer.

Provided herein is a method for making an aerated strained fermented dairy composition. The method includes providing a strained fermented dairy ingredient, producing a stabilized base, aerating the stabilized base to a density of from about 0.5 g/cc to about 1.0 g/cc. The stabilized base is produced by admixing a gelatin slurry into the strained fermented dairy ingredient and admixing a pasteurized emulsifier composition into the strained fermented dairy ingredient, the pasteurized emulsifier composition comprising wetting agent and a lactylated emulsifier.

These and various other features and advantages will be apparent from a reading of the following detailed description.

### BRIEF DESCRIPTION OF THE DRAWINGS

FIG. 1 shows a schematic of a method for producing an aerated strained fermented dairy composition according to an embodiment.

FIG. 2 shows a schematic of a method for producing an aerated strained fermented dairy composition according to an embodiment.

### DETAILED DESCRIPTION

While improvements have been recently made in strained fermented dairy products, such as Greek style yogurt, few developments have been made in producing different types of strained fermented dairy products to satisfy consumer tastes. In addition, many consumers prefer a combination of product attributes, including high protein, low fat, reduced ingredient lists, and low calories, while also demanding an enjoyable eating experience, thus providing a challenge for formulating strained fermented dairy products that meet consumer expectations.

It has been discovered that a strained fermented dairy composition can be aerated and retain a relatively low density over an extended period of time (e.g., at least 7 days to at least 60 days). Such an aerated strained fermented dairy composition can provide an enjoyable eating experience for consumers wanting new types of strained fermented dairy products. Methods and compositions relating to an aerated strained fermented dairy composition are described herein.

A method for producing an aerated strained fermented dairy composition includes, generally, the steps of producing a stabilized base comprising a strained fermented dairy ingredient, gelatin, and an emulsifier composition, and aerating the stabilized base.

As used herein, the term “strained fermented dairy ingredient” refers to a fermented dairy base from which substantially all (i.e., preferably greater than 90%, or more preferably greater than 98%) of the whey has been removed. Whey can be removed from a fermented dairy ingredient using any appropriate method, including by use of a filter (e.g., plastic, metal, or cloth strainer, such as cheese cloth, filtration equipment, or ultrafiltration equipment) or centrifugation, in order to produce a strained fermented dairy ingredient. Suitable fermented dairy bases for the production of a strained fermented dairy ingredient include, for example yogurt, kefir, buttermilk, and the like, and can be derived from any appropriate dairy source, including a raw or pasteurized and/or homogenized milk or milk fraction, such as whole milk, skim milk, condensed milk, dried milk, cream, and the like. Cow's milk is preferred, but milk can be sourced from any appropriate mammal, such as goats, sheep, horses, and the like. In a preferred embodiment, pasteurized milk (e.g., skim cow's milk) is combined with water and a fermentation starter culture in the absence of additional ingredients and fermented to produce a fermented dairy base.

Although the methods described herein are directed to the use of fermented dairy bases having a pH in the range of from about 4.3 to about 4.7, it is to be understood that fermented dairy bases having pH outside of this range may also be used.

A strained fermented dairy ingredient suitable for use in a method provided herein can have up to about 10% by weight fat, preferably less than about 7% by weight. Although the methods provided herein can be used with strained fermented dairy ingredients containing fat, the methods also work surprisingly well with a strained fermented dairy ingredient containing 0% by weight fat. The amount of fat included in a strained fermented dairy ingredient can be selected to provide a desired level of fat in the aerated strained fermented dairy composition. For example, a fat free strained fermented dairy ingredient can be selected to produce a low calorie aerated strained fermented dairy composition, while a strained fermented dairy ingredient having a higher fat content can be used to produce a more decadent aerated strained fermented dairy composition. Fat content of the aerated strained fermented dairy composition need not be limited by the fat content of the strained fermented dairy ingredient, however. A fat-containing ingredient (e.g., cream, oils, and/or fat-containing inclusions) may be added separately to provide the desired fat content in an aerated strained fermented dairy composition provided herein.

A strained fermented dairy ingredient can also include from about 7% by weight to about 15% by weight protein, preferably from about 8% to about 12% by weight. The amount of protein included in a strained fermented dairy ingredient used in a method provided herein can be selected to provide a desired amount of protein in the aerated strained fermented dairy composition and/or to provide certain advantages during the manufacturing process, such as providing a viscosity that pumps or blends relatively easily.

A stabilized base, as provided herein, can be produced by admixing a strained fermented dairy ingredient with a hydrocolloid and an emulsifier composition using any appropriate method and equipment. For example, a hydrocolloid and/or an emulsifier composition can be admixed with a strained fermented dairy ingredient using a vat mixer or by pumping the combined ingredients through one or more static mixers. Preferably, the method and equipment used to admix a hydrocolloid and/or an emulsifier composition with a strained fermented dairy ingredient is sufficient to mix the ingredients, but not interfere with setting of the aerated strained fermented composition. For example, a strained fermented dairy ingredient can be suitably admixed with a hydrocolloid and/or an emulsifier composition using a vat mixer at a speed of about 5 to 15 rpm.

Suitable hydrocolloids preferably include cold set gels, such as, for example, gelatin, agarose, agar-agar, gellan, carrageenan, and combinations thereof. However, glucomannan and/or xanthan gum may also be suitably used as a hydrocolloid in a method provided herein.

Gelatin (e.g., bovine gelatin, porcine gelatin, or piscine gelatin) is most preferably used in a method provided herein. Bloom strength of a gelatin suitable for use in a method provided herein can be from about 200 to 250, or from about 220 to 230. Gelatin can be provided as a slurry comprising about 10% to about 35% by weight, preferably from about 25% to about 30% by weight, dissolved gelatin. Typically, a gelatin slurry is added to a strained fermented dairy ingredient at a temperature greater than the gelling temperature of the gelatin, preferably at a temperature of from about 100° F. to about 170° F., or more preferably, from about 120° F. to about 170° F. In some embodiments, the temperature at which a gelatin slurry is combined with a strained fermented dairy ingredient can be adjusted to be below a temperature that would damage or kill any desirable microbes in the strained fermented dairy ingredient. A gelatin slurry need not be the same temperature as the strained fermented dairy ingredient to which it is admixed. For example, the strained fermented dairy ingredient can be from about 90° F. to about 120° F., or from about 100° F. to about 115° F., while the gelatin slurry is at a temperature of from about 120° F. to about 170° F. when they are admixed.

In some embodiments, a hydrocolloid used in a method provided herein can be pasteurized prior to being combined with a strained fermented dairy ingredient. Any method suitable for the selected hydrocolloid can be used to pasteurize the hydrocolloid. A pasteurized gelatin slurry, for example, can be produced by heating gelatin in water or other aqueous liquid to a temperature of at least 150° F. (e.g., from about 150° F. to about 170° F.) for at least 30 minutes.

The amount of hydrocolloid admixed with a strained fermented dairy ingredient should be sufficient, in combination with an emulsifier composition described herein, to maintain a density of from about 0.5 g/cc to about 1.0 g/cc in an aerated strained fermented dairy composition for at least 7 days at about 35° F. to about 45° F. For example, a gelatin slurry can be added to a strained fermented dairy ingredient in an amount sufficient to result in an aerated strained fermented dairy composition having from about 0.3% to about 1.5% gelatin by weight or, more preferably, from about 0.4% to about 0.8% gelatin by weight.

In some embodiments, a viscosity of a combination of a strained fermented dairy ingredient and a hydrocolloid can be predictive of an aerated strained fermented dairy composition that can maintain a desired density for at least 7 days. Viscosity of the a combination of the strained fermented dairy ingredient can be measured at 40° F. using a Brookfield viscometer with a T-bar spindle 96 on the Helipath™ setting. Viscosity can range from about 140,000 cps to about 260,000 cps, preferably from about 160,000 cps to about 200,000 cps.

In some embodiments, a dynamic viscosity of a combination of a strained fermented dairy ingredient and a hydrocolloid can be predictive of an aerated strained fermented dairy composition that can maintain a desired density for at least 7 days. Dynamic viscosity can be measured at 50° F. using a Viscometer Haake VT 550 (ThermoFisher Scientific, Inc., MA, USA) with the following settings: Initial rotation: 60 rotations/minute for 60 seconds; Rotation ramp up: 60 rotations/minute to 600 rotations/minute over 60 seconds; Measurement at end of Initial rotation. Dynamic viscosity can range from about 1.7 Pa*s to 2.7 Pa*s, preferably from about 2.0 Pa*s to about 2.4 Pa*s. However, in some embodiments when using a strained fermented dairy ingredient having a protein content greater than 10%, a higher dynamic viscosity, e.g., from about 2.5 Pa*s to about 4.0 Pa*s, may be appropriate.

In addition to a hydrocolloid, a pasteurized emulsifier composition is also admixed with a strained fermented dairy ingredient to produce a stabilized base. A pasteurized emulsifier composition suitable for use in a method provided herein includes a wetting agent and a lactylated emulsifier (e.g., lactylated mono- and diglycerides) that have been pasteurized using a known process, such as high temperature, short time pasteurization. Examples of wetting agents include, for example, diacetyl tartaric acid esters of mono- and diglycerides (DATEM), polysorbates, propylene glycol esters, sodium dodecyl sulphate, sodium stearyl lactylate, and mixtures thereof. One particularly preferred wetting agent for use in a method provided herein is DATEM.

In some embodiments, a pasteurized emulsifier composition can comprise an aqueous solution including a wetting agent in an amount of from about 0.5% to about 1.5% and a lactylated emulsifier in an amount of from about 7% to about 15%, which can be admixed with a strained fermented dairy ingredient in an amount sufficient to result in an aerated strained fermented dairy composition having from about 0.01% to about 0.1% wetting agent and about 0.2% to about 1% lactylated emulsifier.

In some embodiments, a pasteurized emulsifier composition can include additional ingredients such as, for example, a fruit ingredient, a flavor ingredient, a sweetener, an edible organic acid, or a color ingredient. In some embodiments, a pasteurized emulsifier composition can be combined with the selected hydrocolloid to be admixed with a strained fermented dairy ingredient. Thus, a pasteurized emulsifier composition can be admixed with a strained fermented dairy ingredient in the same step as the selected hydrocolloid, or in a separate step, to produce a stabilized base.

In embodiments where a pasteurized emulsifier composition includes ingredients that cannot be pasteurized, such ingredients are preferably otherwise treated to reduce microbial content prior to addition to the pasteurized lactylated emulsifier and wetting agent.

In some embodiments, the pH of the selected hydrocolloid and/or the pasteurized emulsifier composition can be adjusted to a pH of from about 3.7 to about 4.7 to reduce acid shock to the strained fermented dairy ingredient. Adjustment of pH can be achieved using edible organic acids (e.g., citric acid, tartaric acid, lactic acid, malic acid, succinic acid, or a combination thereof) and/or buffer systems including edible organic acids. However, the pH of either the selected hydrocolloid or the pasteurized emulsifier composition need not be adjusted in a method provided herein to successfully produce an aerated strained fermented dairy composition.

In some embodiments, the temperature of a stabilized base adjusted to a temperature below 100° F., preferably to about 40° F. to about 85° F., before aeration. In some embodiments, if a hydrocolloid and pasteurized emulsifier are added separately to a strained fermented dairy ingredient, the temperature can be adjusted to a temperature below 100° F. before or after addition of the pasteurized emulsifier.

A stabilized base is aerated to a density that is less than that of the strained fermented dairy ingredient used, preferably to a density of from about 0.5 g/cc to about 1.0 g/cc, more preferably to a density of from about 0.65 g/cc to about 0.75 g/cc, to form an aerated strained fermented dairy composition. A strained fermented ingredient typically has a density of from about 1.03 g/cc to about 1.10 g/cc.

Aeration can be performed using any suitable protocol and equipment. For example, an aerator, such as a Tanis Rotoplus 250 aerator (Tanis Food Tec, The Netherlands) can be used incorporate a gas into the stabilized base. Suitable gases include any nontoxic, preferably odorless and tasteless, gas such as air, nitrogen, nitrous oxide, carbon dioxide, and combinations thereof. The amount of air incorporated into a stabilized base can be sufficient to increase the volume of the stabilized base by about 30% to about 130%, preferably from about 40% to about 60%, to produce an aerated strained fermented dairy composition.

The stabilized base can be maintained at a temperature of from about 40° F. to about 85° F., preferably from about 40° F. to about 60° F., and a pressure of from about 30 psi to about 60 psi, preferably from about 35 psi to about 50 psi, during aeration to reach the desired density and/or to result in an aerated strained fermented dairy composition that can maintain the desired density over at least 7 days.

Following aeration, an aerated strained fermented dairy composition can be transitioned slowly from the pressure maintained during aeration to atmospheric temperature to facilitate maintenance of the desired density.

In some embodiments, an aerated strained fermented dairy composition can be held for a period of time, up to 60 minutes, preferably less than about 15 minutes, at a temperature of about 35° F. to about 60° F., preferably about 50° F. to about 55° F., prior to packaging.

In some embodiments, bubbles in an aerated strained fermented dairy composition can form. Bubbles in an aerated strained fermented dairy composition may not be initially be visible following aeration, but rather may become visible within about 24 hours to 48 hours after aeration. Bubbles in an aerated strained fermented dairy composition can be from about 130 μm to about 30,000 μm in diameter.

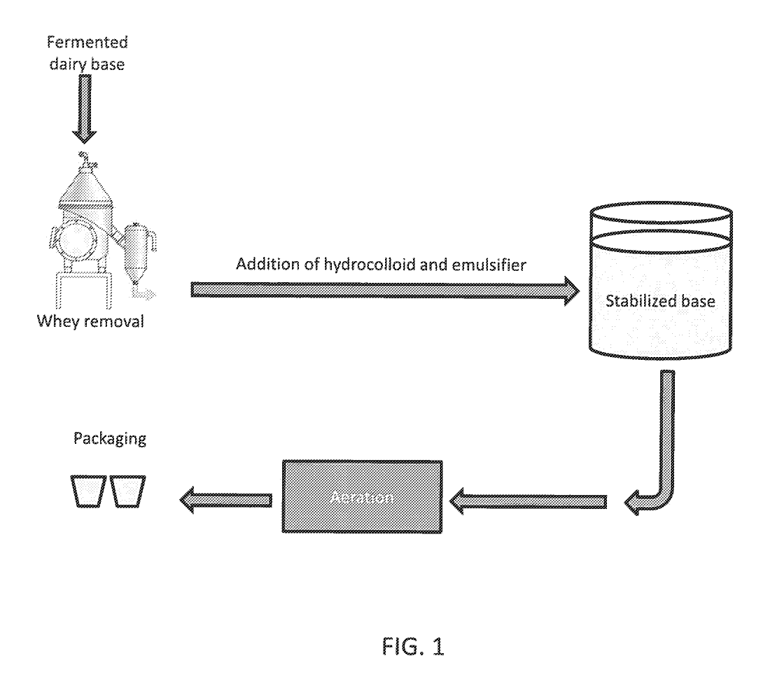

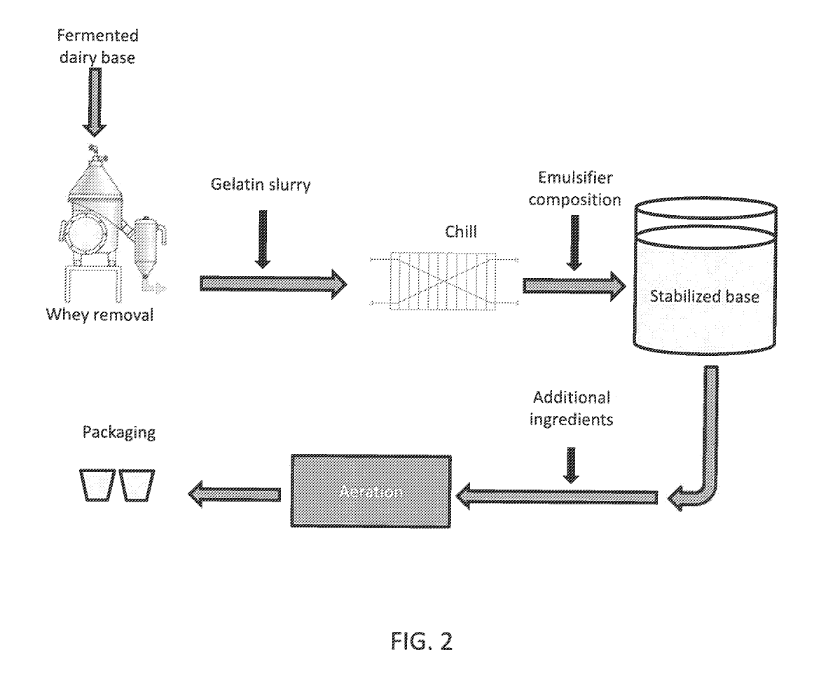

A method provided herein can optionally include additional steps. FIGS. 1 and 2 illustrate embodiments including additional steps. Some additional steps can include, for example, fermentation of a dairy ingredient to produce a fermented dairy base, removing whey from a fermented dairy base to produce a strained fermented dairy ingredient, pasteurizing a fermented dairy base or strained dairy base, and/or adding a live and active culture to a fermented dairy base, strained dairy base, stabilized base, or aerated strained fermented dairy composition.

In some embodiments, an additional step can include addition of a nutritive or non-nutritive sweetener (e.g., sucrose, fructose, stevia extract, sucralose, and the like), a flavor ingredient (e.g., natural and/or artificial fruit flavor, vanilla flavor, caramel flavor, chocolate flavor, and the like), a color ingredient (e.g., natural colors, artificial dyes, lakes, and other additives that impart color), a fat-containing ingredient (e.g., cream, vegetable oil, and the like), a fruit and/or vegetable ingredient, and/or a nutritional ingredient (e.g., vitamins, minerals, and the like) to a strained fermented dairy ingredient, an emulsifier composition, a stabilized base, and/or an aerated strained fermented dairy composition to provide a desired flavor, sweetness, texture, and/or color to the aerated strained fermented dairy composition. For example, a fruit puree can be added to a stabilized base prior to aeration to produce a fruit flavored aerated strained fermented dairy composition. In another example, a particulate (e.g., a confection, chocolate pieces, dough-like pieces, nuts, and the like) can be added to a strained fermented dairy ingredient, an emulsifier composition, a stabilized base, and/or an aerated strained fermented dairy composition to provide a desired flavor, texture, and/or appearance to the aerated strained fermented dairy composition. See, for example, U.S. Patent Publication No. 2006/0068075 and U.S. Pat. No. 5,378,483 which are incorporated herein in their entireties.

An aerated strained fermented dairy composition produced using a method provided herein can comprise about 65% to about 90%, preferably about 75% to about 85%, of a strained fermented dairy ingredient, about 0.3% to about 1.5%, preferably about 0.4% to about 0.8% hydrocolloid, about 0.01% to about 0.1% wetting agent and about 0.2% to about 1% lactylated emulsifier. In some embodiments, an aerated strained fermented dairy composition produced using a method provided herein can contain less than 0.4% starch by weight.

In some embodiments, an aerated strained fermented dairy composition can include a live and active culture. A live and active culture can originate from fermentation during the production of a fermented dairy base or can be added at any point during the production of an aerated strained fermented dairy composition. Microbes suitable for inclusion in an aerated strained fermented dairy composition include any one or a combination of microbes used for the production of a fermented dairy base, including for example, Streptococcus salivarius subsp. thermophilus, Lactobacillus delbrueckii subsp. Bulgaricus, other Lactobacillus species (e.g., L. acidophilus, L. helveticus, L. casei, L. paracasei, L. brevis, L. buchneri, L. fermentum, L. lactis, L. rhamnosus, L. gasseri), Lactococcus species (e.g., L. lactis subsp. lactis, L. lactis subsp. cremoris, L. lactis subsp. diacetylactis), Leuconostoc species (e.g., L. cremoris, L. mesenteriodes, L. lactis), Bifidobacterium species (e.g., B. animalis subsp. lactis, B. bifidim), and the like.

An aerated strained fermented dairy composition produced using a method provided herein typically has a density of from about 0.5 g/cc to about 1.0 g/cc, more preferably to a density of from about 0.65 g/cc to about 0.75 g/cc.

An aerated strained fermented dairy composition provided herein can have a viscosity of from about 50,000 cps to about 200,000 cps, preferably from about 60,000 to about 90,000 cps, after about 24 to 48 hours following aeration. Viscosity can be measured at 40° F. using a Brookfield viscometer (Brookfield Engineering Laboratories, MA, USA) with a T-bar spindle 94 on the Helipath™ setting. An aerated strained fermented dairy composition provided herein typically reaches the indicated viscosity by about 48 hours after packaging.

A packaged aerated strained fermented dairy composition can have a compressibility of about 300 to about 800 g force, preferably about 400 to about 600 g force as determined using the second penetration measurement of a TA.XTPlus texture analyzer and Texture Exponent software (Texture Technologies, Hamilton, Mass., USA) with an appropriately sized probe and the following settings: Test Mode: compression, Pre-Test Speed: 10.00 mm/sec, Test Speed: 10.00 mm/sec, Post-Test Speed: 10.00 mm/sec, Target Mode: distance, Distance: 20.0 mm, Count: 2, Trigger Type: auto (force), Trigger Force: 5.0 g. An appropriately sized probe can vary based on the size of the opening of the container. For example, a probe having a diameter of about 50 mm would be an appropriately sized probe for use with a package having an opening with a diameter of about 78 mm.

An aerated strained fermented dairy composition can be packaged in any suitable packaging, such as sealed cups, tubes, and jars. Suitable packaging can comprise any appropriate materials including, for example, plastic, coated paper, glass, coated metal, and combinations thereof. Opaque or clear packaging can be used to contain an aerated strained fermented dairy composition provided herein. However, it is to be understood that clear packaging, unless treated to reduce light transmission into the package, may reduce the shelf life of the aerated strained fermented dairy composition.

In some embodiments, an aerated strained fermented dairy composition provided herein can be used as an ingredient in another food product. For example, an aerated strained fermented dairy composition can be used as a layer in a layered packaged food product. Additional layers can include, for example, a thin, crispy sweetened coating, such as described in PCT Publication No. WO2003068001, which is incorporated in its entirety herein, to produce a crème brulee like food product, a fruit puree to produce a fruit-on-top or fruit-on-bottom type yogurt product, another aerated strained fermented dairy composition of a different color and/or flavor or a pudding to produce a parfait type food product, and the like.

Packaging of a packaged food product including an aerated strained fermented dairy composition can include any suitable packaging. In some embodiments, packaging for a packaged food product including an aerated strained fermented dairy composition can be designed to provide a desired eating experience. For example, packaging for a crème brulee like food product may resemble a ramekin, while packaging for a parfait type food product may have one or more clear portion to display layers.

The following examples are intended to illustrate particular embodiments, and are not intended to limit the scope, of the described invention.

### EXAMPLES

### Example 1

Skim cow's milk, water and water were blended, homogenized, and pasteurized. The mixture was then cooled and inoculated with a yogurt culture. The mixture was fermented using a standard yogurt fermentation protocol to produce a non-fat yogurt base.

The non-fat yogurt base was filtered to remove the whey using a separator with a 0.2 μm screen to produce a strained yogurt ingredient. The strained yogurt ingredient had a protein content of about 9% and a density of about 1.05 g/cc to about 1.08 g/cc. The strained yogurt ingredient was held at a temperature of about 100° F. to about 115° F.

A pasteurized gelatin slurry was produced by combining about 25-30% by weight gelatin in water heating to a temperature of 125° to about 190° F. for 30 minutes and then held at a temperature of about 120° F. to about 140° F. The pasteurized gelatin slurry was mixed with the strained yogurt ingredient to at a rate of about 2.5 parts gelatin slurry to 97.5 parts strained yogurt ingredient, and then cooled to a temperature of about 40° F. to about 60° F. The cooled strained yogurt/gelatin mixture was smoothed using a high shear pump.

Viscosity of the cooled, smoothed strained yogurt/gelatin mixture was measured at 40° F. using a Brookfield viscometer with a T-bar spindle 96 on the Helipath™ setting. Viscosity ranged from about 140,000 cps to about 260,000 cps.

Dynamic viscosity of the cooled, smoothed strained yogurt/gelatin mixture was measured at 50° F. using a Viscometer Haake VT 550 (ThermoFisher Scientific, Inc., MA, USA) with the following settings: Initial rotation: 60 rotations/minute for 60 seconds; Rotation ramp up: 60 rotations/minute to 600 rotations/minute over 60 seconds; Measurement at end of Initial rotation. Dynamic viscosity ranged from about 2.0 Pa*s to 2.4 Pa*s.

A pasteurized emulsifier composition was produced by combining about 10% by weight lactylated mono- and diglycerides and about 1% by weight DATEM in water and pasteurizing using a high temperature, short time pasteurizing protocol. The pasteurized emulsifier composition was combined with the strained yogurt/gelatin blend at a rate of about 3 to 5 parts pasteurized emulsifier composition to 80 to 87 parts strained yogurt/gelatin blend to produce a stabilized base. Fruit puree and flavor ingredients were also added.

The stabilized base was aerated with nitrogen gas in a Tanis Rotoplus 250 aerator to a volume 40% to 60% greater than the stabilized base input to produce an aerated strained yogurt composition having a density of from about 0.40 g/cc to about 0.65 g/cc.

The aerated strained yogurt composition was held at a temperature of about 35° F. to 60° F. and then filled into cups with a 78 mm round opening and sealed. The aerated strained yogurt composition had a pH of about 4.4 to about 4.6 and a density of about 0.40 g/cc to about 0.65 g/cc.

Viscosity of the aerated strained yogurt composition was measured 24 hours following packaging at 40° F. using a Brookfield viscometer with a T-bar spindle 94 on the Helipath™ setting. Viscosity ranged from about 50,000 cps to about 100,000 cps.

Bubbles were visible in the aerated strained yogurt composition at 24 hours post packaging.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A method for making an aerated strained fermented dairy composition, the method comprising:
a. providing a fermented dairy base having a pH of about 4.3 to about 4.7;
b. removing whey from the fermented dairy base to produce a strained fermented dairy ingredient;
c. producing a stabilized base, comprising:
i. admixing a gelatin slurry into the strained fermented dairy ingredient;
ii. admixing a pasteurized emulsifier composition into the strained fermented dairy ingredient, the pasteurized emulsifier composition comprising wetting agent and a lactylated emulsifier; and
d. aerating the stabilized base to a density of from about 0.5 g/cc to about 1.0 g/cc.

2. The method of claim 1, wherein the pasteurized emulsifier composition comprises lactylated mono- and diglycerides and the wetting agent is selected from the group consisting of diacetyl tartaric acid esters of mono- and diglycerides (DATEM), polysorbates, propylene glycol esters, sodium dodecyl sulphate, sodium stearyl lactylate, and mixtures thereof

3. The method of claim 1, wherein the aerated strained fermented dairy composition includes about 0.01% to about 0.1% wetting agent and about 0.2% to about 1% lactylated emulsifier.

4. The method of claim 1, wherein the pasteurized emulsifier composition further comprises a fruit ingredient, a flavor ingredient, a sweetener, or a color ingredient.

5. The method of claim 1, wherein the pasteurized emulsifier composition is included in the gelatin slurry.

6. The method of claim 1, wherein the gelatin slurry comprises about 10% to about 35% gelatin by weight.

7. The method of claim 1, wherein the gelatin slurry is pasteurized.

8. The method of claim 1, wherein the gelatin slurry is at a temperature of from about 120° F. to about 170° F.

9. The method of claim 1, wherein the stabilized base is aerated at a temperature of about 40° F. to about 85° F.

10. The method of claim 1, wherein the protein content of the strained fermented dairy ingredient is from about 7% to about 15% by weight.

11. The method of claim 1, wherein the strained fermented dairy ingredient has a fat content of from 0% to about 10% by weight.

12. The method of claim 1, wherein the aerated strained fermented dairy composition comprises gelatin in an amount of from about 0.3% to about 1.5% by weight.

13. The method of claim 1, wherein the aerated strained fermented dairy composition has a fat content of from 0% to about 8% by weight.

14. An aerated strained fermented dairy composition having a viscosity of about 50,000 cps to about 200,000 cps at 40° F. and having a density of from about 0.5 g/cc to about 1.0 g/cc for at least 7 days at 35° F. to 45° F. at atmospheric pressure, comprising:
a. about 65% to about 90% of a strained fermented dairy ingredient;
b. about 0.3% to about 1.5% gelatin;
c. about 0.01% to about 0.1% wetting agent and about 0.2% to about 1% lactylated emulsifier; and
d. an aerating gas.

15. The aerated strained fermented dairy composition of claim 14, wherein the lactylated emulsifier is lactylated mono- and diglycerides and the wetting agent is selected from the group consisting of diacetyl tartaric acid esters of mono- and diglycerides (DATEM), polysorbates, propylene glycol esters, sodium dodecyl sulphate, sodium stearyl lactylate, and mixtures thereof.

16. The aerated strained fermented dairy composition of claim 14, wherein the aerated strained fermented dairy composition has a starch content of less than 0.4% by weight.

17. The aerated strained fermented dairy composition of claim 14, further comprising a live and active culture.

18. The aerated strained fermented dairy composition of claim 14, wherein the aerated strained fermented dairy composition has a compressibility of about 300 g force to about 800 g force.

19. The aerated strained fermented dairy composition of claim 14, further comprising particulates.

20. A layered packaged food product comprising the aerated fermented dairy composition of claim 14 as a layer.

21. A method for making an aerated strained fermented dairy composition, the method comprising:
a. providing a strained fermented dairy ingredient;
b. producing a stabilized base, comprising:
i. admixing a gelatin slurry into the strained fermented dairy ingredient;
ii. admixing a pasteurized emulsifier composition into the strained fermented dairy ingredient, the pasteurized emulsifier composition comprising wetting agent and a lactylated emulsifier; and
c. aerating the stabilized base to a density of from about 0.5 g/cc to about 1.0 g/cc.
